(19) United States
(12) Patent Application Publication
(10) Pub. No.: US 2021/0207877 A1
(43) Pub. Date: Jul. 8, 2021

(54) REFRIGERATOR

(71) Applicant: LG Electronics Inc., Seoul (KR)

(72) Inventor: Taejin YEOM, Seoul (KR)

(21) Appl. No.: 17/057,436

(22) PCT Filed: Apr. 22, 2020
(86) PCT No.: PCT/KR2020/005322

§ 371 Date: Nov. 20, 2020

(30) Foreign Application Priority Data
Apr. 26, 2019 (KR) 10-2019-0049387

(51) Int. Cl. F25D 23/02; F25D 25/02

(52) U.S. Cl. CPC F25D 23/028; F25D 29/005; F25D 25/025

(57) ABSTRACT

Provided is a refrigerator including a cabinet configured to form a storage compartment; and a door configured to open or close the storage compartment and to have a button device for receiving a command based on an operation of a user, wherein the button device includes a button part having a button receiving an operation force of the user and a detection part having a switch for detecting the operation force of the button, wherein the button part is formed of a flexible material deformable by an external force and a plurality of holes are provided around the button.

### TECHNICAL FIELD

The present disclosure relates to a refrigerator.

### BACKGROUND ART

In general, a refrigerator is a device for freezing or refrigerating food or the like by discharging cold air generated by a refrigeration cycle including a compressor, a condenser, an expansion valve, an evaporator, and the like to lower a temperature in the refrigerator.

The refrigerator may include a freezing compartment for freezing and storing food or beverage and a refrigerating compartment for storing food or beverage at a low temperature, as storage compartments.

The refrigerator may be classified into a top mount type in which the freezing compartment is located at the top of the refrigerating compartment, a bottom freezer type in which the freezing compartment is located at the bottom of the refrigerating compartment, and a side-by-side type in which the freezing compartment and the refrigerating compartment are divided into left/right sides.

Such a refrigerator may include doors that open and close the freezing compartment and the refrigerating compartment, and thus the freezing compartment or the refrigerating compartment may be accessed through each door.

In general, a user interface for inputting a command by a user or displaying information for the user may be provided on the front of the refrigerator. The user interface may include, for example, a button for the user to press. When the button is pressed, a light emitting part located near the button is turned on and light is irradiated to the button.

A refrigerator door is disclosed in Japanese Patent Laid-Open Publication No. 2002-90059, which is a related art document.

A refrigerator door of the related art document includes a display operation unit installed at the front. The display operation unit includes an operation panel having a display device door and an operation button, a button part located at the rear of the operation panel and having a pressed part, and a printed board located at the rear of the button part and on which an LED element is installed.

The operation panel includes a synthetic resin plate material and a synthetic resin sheet attached to a surface thereof, and holes are formed in the plate material so that the sheet may be deformed. Accordingly, a portion of the sheet corresponding to the hole serves as a button.

A portion to be pressed (or pressed portion) is located behind the button, and the LED element is arranged to face the pressed portion.

A switch is disposed on a side of the LED element, and the button component further includes a switch push unit for pressing the switch.

The button component includes a support body and two support arms extending from the support body, the pressed portion extends to the two support arms, and a switch push portion extends from the pressed portion.

According to such related art document, when the user presses the button, the button presses the pressed portion, and the switch push portion extends due to deformation of the pressed portion.

Since the pressed portion is connected to the two support arms, the pressed portion returns to its original position after the pressed portion is pressed by elastic deformation of the support arm.

However, when the pressed portion is repeatedly pressed, a restoring force gradually decreases after the support arm is elastically deformed, causing a problem in that the pressed portion cannot return to its original position after being pressed.

In this case, even if the user presses the button, the button may not press the pressed portion, or when the deformation amount of the support arm is large, the switch push unit may press the switch even if the button is not pressed.

In addition, light emitted from the LED element is irradiated to the button through the pressed portion, and here, if the pressed portion is not completely aligned with the LED element due to deformation of the support arm, there is a disadvantage that light emitted from the LED element does not reach the entire button evenly due to refraction or the like.

In addition, since the LED element is aligned with the pressed portion, a separate switch push portion for pressing the switch is required, thereby increasing a size of the display operation portion.

In addition, while the sheet including the button is formed of a synthetic resin, the exterior of the refrigerator door is formed of a metal material, and thus there is a disadvantage that uniformity of the two components is deteriorated.

### DISCLOSURE

### Technical Problem

An aspect of the present disclosure provides a refrigerator in which deformation of a button may be prevented despite repeatedly pressing the button.

Another aspect of the present disclosure provides a refrigerator in which light emitted from a light emitting part is evenly irradiated along a perimeter of a button.

Another aspect of the present disclosure provides a refrigerator in which a button device is compact.

Another aspect of the present disclosure provides a refrigerator in which waterproof performance of a button device is improved.

Another aspect of the present disclosure provides a refrigerator in which a contact part pushed by a user in a button device has the same texture as the exterior of a refrigerator door, thereby improving uniformity.

### Technical Solution

In one aspect of the present disclosure, there is provided a refrigerator including a button device configured to detect a command input upon receiving a user's operation force.

The button device may include a button part having a button and a detection part including a switch for detecting an operation force of the button, and in order to prevent plastic deformation of the button by a repetitive operation of the button, the button part is formed of a flexible material, and a plurality of holes may be formed around the button.

The button device, for example, may be provided on a door that opens and closes a storage space.

The detection part may further include a light emitting part. The detection part may be installed on the board together with the light emitting part.

The button device may further include a reflective member for reflecting light emitted from the light emitting part.

The reflective member may support the button part and may include a passage through which light travels. The light emitting part and the switch may be accommodated in the passage.

An entrance of the passage may be located adjacent to the board, and an exit of the passage may be located adjacent to the button. A distance from the center of the switch to the light emitting part may be longer than a radius of the exit of the passage.

The button part may further include a pressing part extending toward the switch from a position corresponding to the button. The pressing part may be disposed to face the switch, and the pressing part may press a contact point of the switch.

The button part may further include a protrusion protruding along a circumference of the button.

The button device is located in the door, and the door may include a button hole through which the button part passes. A contact part pushed by the user may be coupled to the protrusion.

The contact part may be formed of the same material as a portion forming the exterior of the door, or may be formed of a different material but have the same texture.

In another aspect of the present disclosure, there is provided a refrigerator including: a cabinet forming a refrigerating compartment; and a door configured to open and close the storage space, and the door may include a button device for receiving a command by a user's operation.

The door may include a rotation type door and a drawer type door. The button device may be provided on the rotation type door. Alternatively, the door may include a plurality of drawer type doors arranged in an up-down direction, and the button device may be disposed on an upper drawer door among the plurality of drawer-type doors.

The button device may include a button part having a button receiving a user's operation force, and a detection part including a switch for detecting the operation force of the button, and the button part may include a plurality of holes formed around the button.

The button part may be formed of a silicon material that can be deformed by an external force. A plurality of holes may be arranged to be spaced apart from each other at a predetermined interval in a circumferential direction of the button.

The door may include a support frame configured to support the button device; and a front frame configured to cover the button device.

The front frame may include a button hole exposing a region corresponding to the button to an outside in the button part.

The button part comprises a protrusion configured to protrude along a circumference of the button. The protrusion may be configured to penetrate the button hole, and a diameter of the protrusion may be equal to or greater than a diameter of the button hole.

The protrusion may have a ring shape, and the button device may further include a contact part coupled with the protrusion in a region formed by the protrusion.

The contact part and the front frame may be formed of a metal material. Or, the front frame may be formed of a metal material and the contact part may be formed of a non-metal material and have the same texture as a texture of the front frame.

The protrusion may include an engaging portion to be engaged with an edge of the contact part.

The contact part may be located in the button hole in a state where the contact part is coupled to the protrusion.

The detection part may include a board on which the switch is installed, and a light emitting part may be installed around the switch on the board. A plurality of light emitting parts may be arranged along a circumference of the switch and spaced apart from each other.

The button part may further include a pressing part. The pressing part may be disposed to face the switch.

The button device may further include a reflective member having a passage in which the light emitting part and the switch are accommodated. Light emitted from the light emitting part may move along the passage.

The reflective member may be configured to support the button part in the housing.

The reflective member may include a body in which an inner circumferential surface forms the passage.

An entrance of the passage may be located adjacent to the board and an exit of the passage may be located adjacent to the button.

A distance from a center of the switch to the light emitting part may be greater than a radius of the exit of the passage.

A diameter of the exit of the passage may be smaller than a diameter of the entrance of the passage.

The reflective member may further include at least one projection inserted into some or all of the plurality of holes.

The button device may further include a housing configured to accommodate the detection part and to support the button part.

The housing may include: a housing body configured to form an accommodation space in which the detection part is accommodated; and an edge part extending from an edge of the housing body. The edge part may support the button part.

The edge part may include a seating part formed to be recessed to allow the button part to be seated therein. The seating part may have a projection to be inserted into the button part.

In another aspect of the present disclosure, there is provided a refrigerator including: a cabinet configured to form a storage compartment; an upper door configured to open and close an upper space of the storage compartment; a lower door configured to open and close a lower space of the storage compartment; a button device provided at the upper door and including a button, a first detection part configured to detect an operation of the button and a light emitting part; a second detection part provided at the upper door; and a controller configured to turn on the light emitting part when a detection signal is output from the second detection part.

The second detection part may be a knock detection part configured to detect a knock applied to the upper door or a proximity sensor configured to detect a user's approach.

The refrigerator may further include: a drawing device configured to automatically draw the lower door.

When the first detection part detects an operation of the button, the lower door may be automatically drawn out by an operation of the drawing device.

The refrigerator may further include a lifting device configured to automatically lifting a container accommodated in the lower door with the lower door drawn out.

When an operation of the button is detected by the first detection part, the container may be automatically lifted by an operation of the lifting device.

The button device may be located at a lower portion of a front surface of the upper door.

The upper door may include a first door and a second door accommodated in the first door so as to be rotatable with respect to the first door. The button device may be located between the second door and the lower door in the first door.

The upper door may include a first door and a second door rotatable with respect to the first door and located at a front of the first door. The button device may be located at a lower portion of a front surface of the second door.

### Advantageous Effects

According to the proposed embodiment, since a plurality of holes are formed around a button to which a user's operation force is transferred, there is an advantage in that deformation of the button may be prevented despite repeated pressing of the button.

In addition, since light emitted from the light emitting part is reflected by the reflective member and then irradiated to the button part, there is an advantage in that light is uniformly formed around the button.

In addition, since a force applied to the button is transferred to the switch by the pressing part located on the opposite side of the button, a path for transferring the operating force of the button to the switch is shortened, thus simplifying the structure and making the button device compact.

In addition, since a diameter of the portion penetrating the hole in the door is larger than a diameter of the hole through which a portion of the button part is exposed to the outside and the button part is formed of a flexible material, water is prevented from entering the door through the hole, thereby improving waterproof performance of the button device.

In addition, in the present embodiment, since the contact part located in front of the button is formed of the same material or has the same texture as the portion forming the exterior of the door, the contact part may have the same texture as the exterior of the refrigerator door, thereby improving uniformity.

### DESCRIPTION OF DRAWINGS

FIG. 1 is a perspective view of a refrigerator according to an embodiment of the present disclosure.

FIG. 2 is a view showing a state where a drawer door is open in a refrigerator.

FIG. 3 is a block diagram of a refrigerator according to an embodiment of the present disclosure.

FIG. 4 is a view showing a state where the button device is separated from a first door of the present embodiment.

FIGS. 5 and 6 are exploded perspective views of a button device according to an embodiment of the present disclosure.

FIG. 7 is a cross-sectional view taken along line 7-7 of FIG. 1.

### MODE FOR INVENTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected or jointed to the latter or may be “connected”, coupled” or “joined” to the latter with a third component interposed therebetween.

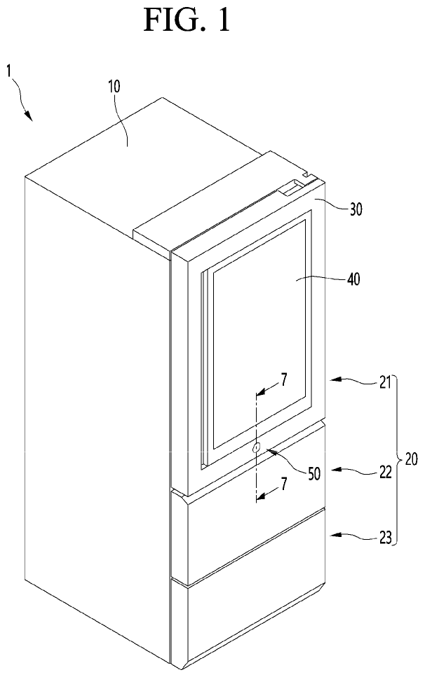

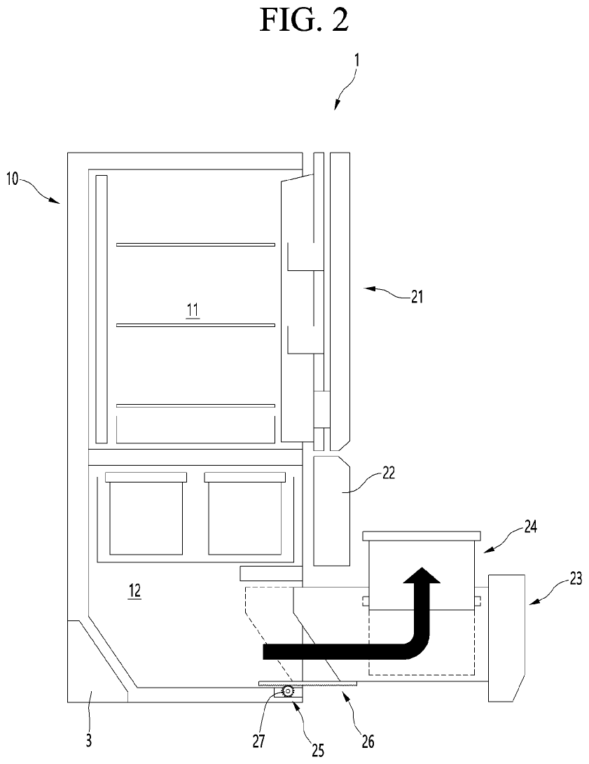

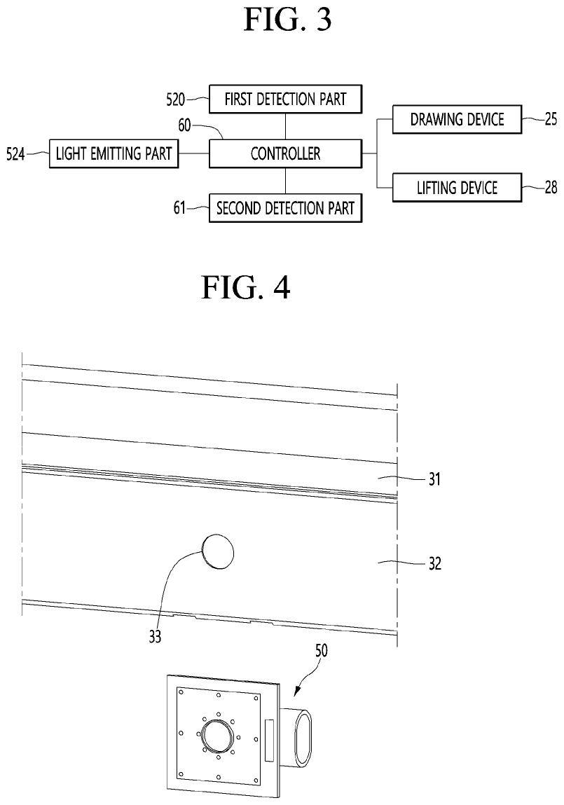

FIG. 1 is a perspective view of a refrigerator according to an embodiment of the present disclosure, FIG. 2 is a view showing a state where a drawer door is open in the refrigerator, and FIG. 3 is a block diagram of a refrigerator according to an embodiment of the present disclosure.

Referring to FIGS. 1 to 3, a refrigerator 1 according to an embodiment of the present disclosure may include a cabinet 10 forming a storage space and a door 20 opening and closing the storage space.

The storage space inside the cabinet 10 may be divided into a plurality of spaces. For example, an upper space 11 of the cabinet 10 may be used as a refrigerating compartment and a lower space 12 may be used as a freezing compartment.

Alternatively, the upper space and the lower space may be independent spaces maintained at different temperatures other than the refrigerating compartment or the freezing compartment.

The door 20 may include a rotating door 21 of a rotating type, and drawer doors 22 and 23 that may be withdrawn in a drawer type.

For example, the rotating door 21 may open and close the upper space 11, and the drawer doors 22 and 23 may open and close the lower space 12.

The lower space 12 may be divided up and down again, and the drawer doors 22 and 23 may include an upper drawer door 22 and a lower drawer door 23.

The present embodiment is described based on the refrigerator in which the rotating door 21 and the drawer doors 22 and 23 are arranged together, but is not limited thereto, and may be applied to all types of refrigerators provided with a drawer-type door.

The rotating door 21 may be referred to as an upper door, and the drawer doors 22 and 23 may be referred to as lower doors.

The rotating door 21 may include, for example, a first door 30 for opening and closing the upper space 11 and a second door 40 rotatable with respect to the first door 30.

Of course, the rotating door 21 may be configured as a single door to open and close the upper space 11.

For example, the second door 40 may be rotatably connected to the first door 30. Of course, it is also possible for the second door 40 to be rotatably connected to the cabinet 10.

The refrigerator 1 may further include a drawing device 25 for drawing out the drawer doors 22 and 23 and a lifting device 28 for lifting a container 24 provided in the drawer doors 22 and 23 in a state where the drawer doors 22 and 23 are drawn out.

Hereinafter, an example in which the lower drawer door 23 is drawn out by the drawing device 25 and the container 24 accommodated in the lower drawer door 23 is lifted by the lifting device 28 will be described.

The drawing device 25 may include a motor, a pinion gear 27 rotated by the motor, and a rack 26 connected to the pinion gear 27.

The rack 26 may be connected to the lower drawer door 23, and when the motor is operated, the rack 26 may be moved forward or backward, so that the lower drawer door 23 may be drawn out or drawn in.

The lifting device 28 may include a support part for supporting the container 24, a motor, and a power transfer part for transferring power from the motor to the support part. In the present embodiment, the lifting device 28 may be implemented by a known technique, so a detailed description thereof will be omitted.

The refrigerator 1 according to the present embodiment may further include a button device 50 for inputting an automatic draw-out command of at least one of the upper drawer door 22 and the lower drawer door 23.

The button device 50 may include a first detection part 520. When the user's button operation is detected by the first detection part 520, the controller 60 may operate the drawing device 25 and/or the lifting device 28.

For example, when a button operation is detected by the first detection part 520, the controller 60 may operate the drawing device 25 to allow the lower drawer door 23 to be drawn out.

When the drawing of the lower drawer door 23 is completed, the controller 60 may operate the lifting device 28 to cause the container 24 to rise from the drawn lower drawer door 23.

Therefore, according to the present embodiment, there is no need for the user to directly open the lower drawer door 23 and the lower drawer door 23 may be opened, thereby improving user convenience.

In addition, when the lower drawer door 23 is open, the container 24 may be automatically raised, and thus, user convenience that the user has to take out the container 24 directly from the lower drawer door 23 may be eliminated.

Of course, in this embodiment, one of the drawing device 25 and the lifting device 28 may be omitted.

For example, if the refrigerator 1 includes only the drawing device 25, the lower drawer door 23 may be withdrawn automatically by the drawing device 25 when a button operation is detected by the first detection part 520.

Alternatively, if the refrigerator 1 includes only the lifting device 28, the lower drawer door 23 may be manually slidably drawn out and a sensor (not shown) may detect completion of drawing of the lower drawer door 23. In this state, the button operation may be detected by the first detection part 520. In this case, the lifting device 28 may be operated so that the container 24 may be automatically lifted.

In the present embodiment, the button device 50 may be located higher than the drawer doors 22 and 23 which are slidably drawn in and out.

For example, the button device 50 may be provided on the rotating door 21 located above the drawer doors 22 and 23.

When the button device 50 is provided on the rotating door 21, the user may easily access the button device 50. For example, the user may access the button device 50 in a standing state without bending the waist.

In addition, the button device 50 may be located on a front surface of the rotating door 21 so that the user may easily operate the button device 50.

The button device 50 may be located at the first door 30 or the second door 40.

For example, when the second door 40 is rotatably connected to the first door 30 and a part of the first door 30 is accommodated in the second door 40, the button device 50 may be located on the first door 30.

In this case, the button device 50 may be located adjacent to the drawer doors 22 and 23 so that the user may easily operate the button device 50.

The button device 50 may be located on a front lower side of the rotating door 21. For example, the button device 50 may be located at the center of the front lower side of the rotating door 21.

The button device 50 may be located under the second door 40 at the first door 30. That is, the button device 50 may be located between the second door 40 and the drawer doors 22 and 23.

As another example, when the second door 40 is located at the front of the first door 30 and the sizes of the second door 40 and the first door 30 are substantially the same, the button device 50 may be located on the second door 40.

Even in this case, the button device 50 may be located at the center of the front lower side of the second door 40.

The refrigerator 10 according to the present embodiment may further include a second detection part 61. When a detection signal is output from the second detection part 61, the light emitting part 524 of the button device 50 to be described later may be turned on.

The second detection part 61 may be, for example, a proximity sensor for detecting that the user is close to the refrigerator 1 within a predetermined distance.

Alternatively, the second detection part 61 may be a knock detection part for detecting a knock applied by a user to the rotating door 21.

The knock detection part may include, for example, a microphone that detects sound waves generated by knocking. Since the knock detection part may be implemented by a known technique, a detailed description will be omitted.

However, in the present embodiment, when the second detection part 61 detects a knock applied to the rotating door 21, the light emitting part 524 of the button device 50 is turned on.

If a button operation is not detected until a set time has elapsed after the light emitting part 524 was turned on, the light emitting part 524 may be turned off.

In addition, when the light emitting part 525 is turned on and the button operation is detected, the light emitting part 524 remains on, and when the operation of the drawing device 24 and/or the lifting device 28 is completed, the light emitting part 525 may be turned off.

Alternatively, when the light emitting part 525 is turned on and the button operation is detected, the light emitting part 525 will blink until the operation of the drawing device 24 and/or the lifting device 28 is completed.

As another example, the button device 50 may be located at the upper drawer door 22 among the plurality of drawer doors 22 and 23.

Hereinafter, the button device 50 will be described in detail.

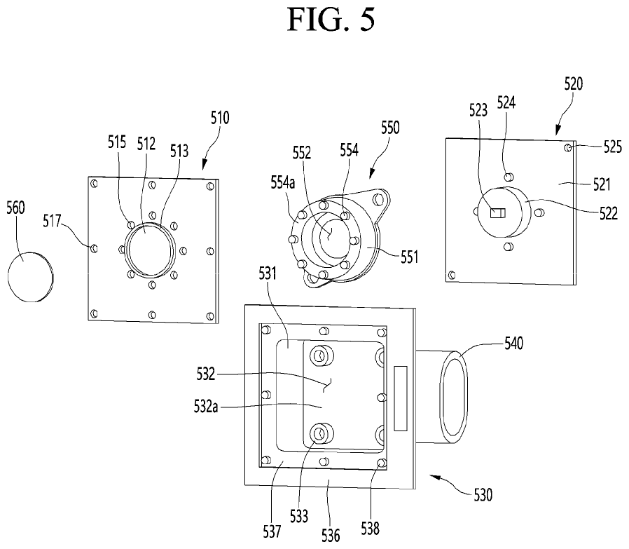

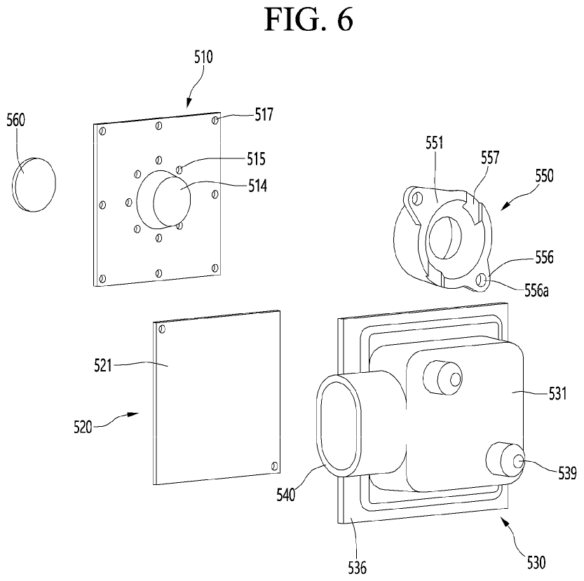

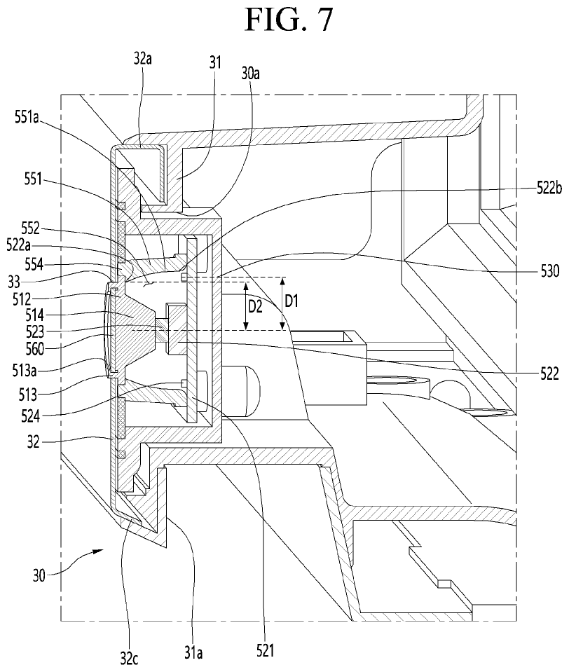

FIG. 4 is a view showing a state where the button device is separated from the first door of the present embodiment, FIGS. 5 and 6 are exploded perspective views of the button device according to an embodiment of the present disclosure, and FIG. 7 is a cross-sectional view taken along line 7-7.

Referring to FIGS. 4 to 7, the first door 30 may have a handle 31a at a lower side thereof for the user to grip. The handle 31a may be formed by depressing a portion of the lower surface of the first door 30 upward.

The button device 50 may be located above the handle 31a.

The first door 30 may include a support frame 31 for supporting the button device 50. The support frame 31 may include an opening 30a through which the button device 50 passes.

The first door 30 may further include a front frame 32 coupled to a front surface of the support frame 31.

In a state where the front frame 32 is coupled to the support frame 31, the front frame 32 may cover the front surface of the button device 50.

The front frame 32 may have a button hole 33 through which a part of the button device 50 is exposed.

For example, at least an area in the button part 510 corresponding to the button 512 may be exposed to the outside through the button hole 33.

In addition, the front frame 32 may include extending part 32a and 32c extending from upper and lower sides to be firmly coupled to the support frame 31, and the extending part 32a and 32c may be accommodated in a space formed at the support frame 31.

The button device 50 may include a button part 510 including a button 512 and a first detection part 520 for detecting an operation of the button 512.

The button part 510 may be formed of a flexible material that may be changed in shape by an external force, for example. For example, the button part 510 may be formed of a silicon material.

The button 512 may have a certain area and may be formed in a circular or polygonal shape. In FIG. 5, for example, the button 512 is shown in a circular shape.

A plurality of holes 515 may be formed around the button 512 in a circumferential direction.

For example, the plurality of holes 515 may be arranged at regular intervals in the circumferential direction, while having a constant radius at the center of the button 512.

Accordingly, a virtual line connecting the plurality of holes 515 has a circular shape and is located on the button 512 in an area in which the plurality of holes 515 are formed.

The user's pressing force is transmitted to the button 512. Since the button part 510 is formed of a flexible material, the button 512 may be deformed in a direction away from the direction in which the pressing force is applied.

According to the present embodiment, since a plurality of holes 515 are arranged around the button 512 at regular intervals, even if the pressing force applied to the button 512 leans to either side, the button 512 may be smoothly deformed by the plurality of holes 515.

In addition, after the button 512 is deformed by repeated pressing force by a plurality of holes 512 around the button 512, it may be easily returned to its original state.

In addition, even if an excessive force is applied to the button 512, the force may be distributed to the plurality of holes 512, thereby preventing plastic deformation of the button 512.

The button part 510 including the button 512 may be formed as a whole in a rectangular or square shape.

The button part 510 may include a pressing part 514 protruding in a direction away from the button 512 at a position corresponding to the button 512. The direction away from the button 512 is a direction closer to the first detection part 520.

A cross-sectional area of the pressing part 514 may decrease in a direction away from the button 512. For example, the pressing part 514 may be formed in a truncated cone shape.

In this way, when the pressing part 514 is formed in a truncated cone shape, a weight of the entire button part 510 may be reduced.

The button part 510 may further include a protrusion 513 extending around the button 512. The protrusion 513 may extend from the button part 510 in a direction opposite to the pressing part 514.

The protrusion 513 may be located in an area formed by the plurality of holes 515.

The protrusion 513 may be formed in a circular ring shape, for example. The protrusion 513 may pass through the button hole 33.

A diameter of the button hole 33 of the front frame 31 may be the same as or smaller than an outer diameter of the protrusion 513.

Therefore, with the protrusion 513 passing through the button hole 33, the protrusion 513 completely blocks the button hole 33 to prevent external water from passing through the button hole 33. Accordingly, waterproof performance of the button device 50 may be improved.

A contact part 560 contacted by the user to press the button 512 may be coupled to the protrusion 513.

The contact part 560 may be formed in a disk shape, for example, and a thickness thereof may be smaller than a protruding length of the protrusion 513.

An outer diameter of the contact part 560 may be equal to or greater than an inner diameter of the protrusion 513.

Accordingly, the contact part 560 may be accommodated in a space formed by the protrusion 513 to maintain a fixed state with the protrusion 513 by frictional force with the protrusion 513.

In a state where the contact part 560 is accommodated in the space formed by the protrusion 513, the contact part 560 may be in contact with the button 512.

To prevent the contact part 560 from being separated from the protrusion 513 while the contact part 560 is accommodated in the space of the protrusion 513, an engaging portion 513a to be engaged at an edge of the contact part 560 may be provided.

The engaging portion 513a may be continuously formed along the circumference of the protruding part 513. The engaging portion 513a may extend from the end of the protrusion 513 toward the center.

In this embodiment, with the contact part 560 fixed to the protrusion 513, the contact part 560 may be located at the button hole 33. Accordingly, the contact part 560 may be prevented from protruding forward from the first door 30.

The contact part 560 may be formed of a material different from that of the button part 510.

Since the protrusion 513 in the first door 30 defines a boundary of the contact part 560, if the contact part 560 is formed of a material different from that of the button part 510, the user may easily recognize the contact part 560.

At least the support frame 31 in the first door 30 may be formed of a metal material. The contact part 560 may be formed of a metal material to have uniformity with the support frame 31.

For example, the contact part 560 may be formed of the same metal material as the support frame 31, or the contact part 560 may be formed of a different type of metal material than the support frame 31 but may have the same texture.

Alternatively, the contact part 560 may be formed of a non-metal material and the support frame 31 may be formed to have the same metal texture.

In this case, when the first door 30 is viewed from a distance, the contact part 560 and the support frame 31 may have overall uniformity, and when the first door 30 is viewed from a close position, the contact part 560 may be easily recognized.

The first detection part 520 may include a board 521, a switch 522 installed on the board 521, and one or more light emitting parts 524 disposed around the switch 522.

The first detection part 520 is located behind the button part 510, and the switch 522 is disposed to face the pressing part 514.

In a state where no external force is applied to the button 512 (a state where the button is not operated), a contact point 523 of the switch 522 may be in contact with the pressing part 514 or separated from the pressing part 514.

Here, in a state where no external force is applied to the button 512, even if the contact point 523 of the switch 522 is in contact with the pressing part 514, the contact point 523 may not be pressed by the pressing part 514.

According to the present embodiment, since a force for operating the button 512 is directly transmitted to the switch 522 through the pressing part 514, a path for an operating force of the button 512 to be transmitted to the switch 522 is short to simplify the structure and make the button device compact.

For example, a plurality of light emitting parts 524 may be installed on the board 521. The switch 522 may be located between the plurality of light emitting parts 524. Alternatively, the plurality of light emitting parts 524 may be disposed to surround the switch 522.

The button device 50 may further include a housing 530 accommodating the first detection part 520.

The housing 530 may form an accommodation space 532 for accommodating the first detection part 520.

A support protrusion 533 for supporting the board 521 may be provided on a bottom wall 532a of the accommodation space 532. When the support protrusion 533 protrudes from the bottom wall 532a and the board 521 is supported by the support protrusion 533, the board 521 may be spaced apart from the bottom wall 532a.

For example, a plurality of support protrusions 533 may protrude from the bottom wall 532a. Although not limited, since three or more support protrusions 533 support the board 521, the board 521 may be stably supported.

A fastening hole 525 for fastening a fastening member may be formed in the board 521. The fastening hole 525 may be aligned with some of the plurality of support protrusions 533.

Accordingly, the fastening member may pass through the fastening hole 525 and be fastened to some of the plurality of support protrusions 533.

The housing 530 may further include a fastening boss 539 for fastening the fastening member. The fastening member may be fastened to the fastening boss 539 after passing through the fastening hole 525 and one supporting protrusion 533.

The housing 530 may support the button part 510.

The housing 530 may include a housing body 531 forming the accommodation space 532 and an edge portion 536 extending from an edge of the housing body 531.

The edge part 536 may support the button part 510, and the button part 510 may cover the accommodation space 532.

The edge part 536 may include a seating part 537 in a recessed form in order for the button part 510 to be seated therein.

A fixing protrusion 538 may be formed in the seating part 537, and a protrusion hole 517 into which the fixing protrusion 538 is inserted may be formed at the button part 510.

The housing 530 may further include a wire guide 540 for guiding an electric wire connected to the board 521.

The wire guide 540 forms a guide space therein, and the guide space may communicate with the accommodation space 532.

The button device 50 may further include a reflective member 550 for reflecting light emitted from the light emitting part 524.

The reflective member 550 may include a body 551 forming a passage 552 therein.

The passage 552 may allow light emitted from the light emitting part 524 and light reflected from the reflective member 550 to move therealong.

The body 551 may be in contact with the board 521 and may surround the light emitting part 524 and the switch 522 on the board 521.

For example, in a state where the body 551 is in contact with the board 521, the light emitting part 524 and the switch 522 may be located in the passage 552 in the body 551.

The reflective member 550 may support the button part 510. A protrusion 554 for coupling with the button part 510 may be provided on a support surface 554a that supports the button part 510 in the body 551.

The protrusion 554 may be coupled to at least some of the plurality of holes 515 described above.

In FIG. 5, for example, a plurality of protrusions 554 are formed in the same number as the plurality of holes 515 and are coupled to the plurality of holes 515, respectively.

With the body 551 supporting the button part 510, the pressing part 514 is accommodated in the body 551. That is, the pressing part 514 is located in the passage 552. In this case, the pressing part 514 is spaced apart from the inner circumferential surface 551a of the body 551.

A portion or the entirety of the inner circumferential surface 551a of the body 551 may be formed to decrease in diameter from the board 521 toward the button 512.

Alternatively, a diameter of a portion adjacent to the button 512 on the inner circumferential surface 551a (for example, an exit 522a of the passage 522) may be smaller than a diameter of a portion adjacent to the board 521 on the inner circumferential surface 551a (for example, an entrance 522b of the passage 522).

Accordingly, after the light emitted from the light emitting part 524 in the body 551 is reflected, the reflected light may be collected around the button 512.

The light emitting part 524 located in the body 551 may be disposed so as not to face the exit 522a of the passage 522.

For example, a distance D1 from the center of the switch 522 to the light emitting part 524 is larger than a radius D2 of the exit 522a.

Accordingly, a most portion or the entirety of the light emitted from the light emitting part 524 may be reflected from the inner circumferential surface 551a of the body 551 and then gather around the button 512.

In this embodiment, the button part 510 may be formed of a translucent material, so that light emitted from the light emitting part 524 may be formed on the button part 510.

In a state where the button device 50 is installed on the first door 30, a portion of the button device 50 exposed to the outside of the first door 30 is the protrusion 513.

Therefore, light emitted from the light emitting part 524 may reach the protrusion 513, and the user may recognize the protrusion 513 and the contact part 560 upon checking light reaching the protrusion 513.

However, if light emitted from the light emitting part 524 directly reaches the periphery of the button part 510, especially around the button 512, without being reflected by other structure, light may not entirely reach the protrusion 513 but reach only a portion of the protrusion. As a result, light does not evenly formed on the protrusion 513.

Meanwhile, as in the present embodiment, when light emitted from the light emitting part 524 reaches the periphery of the button 512 after being reflected from the inner circumferential surface 551a of the body 551, the light is not concentrated on a portion of the protrusion 513, and thus there is an advantage in that light is uniformly formed throughout.

The body 551 may further include a coupling part 556 extending in a radial direction, and the coupling part 556 may have a through hole 556a through which a fastening member fastened to the fastening hole 525 of the board 521 passes may be formed.

In addition, the body 551 may have a slot 557 through which an electric wire connected to the board 521 passes.

According to the proposed embodiment, since a plurality of holes are formed around the button to which a user's operation force is transmitted, there is an advantage in that deformation of the button may be prevented despite repeated pressing of the button.

In addition, since light emitted from the light emitting part is irradiated to the button part after being reflected by the reflective member, there is an advantage in that light is uniformly formed around the button.

1. A refrigerator comprising:
a cabinet configured to form a storage space; and
a door configured to open or close the storage space and to have a button device for receiving a command based on an operation of a user,
wherein the button device comprises:
a button part having a button receiving an operation force of the user; and
a detection part having a switch for detecting the operation force of the button,
wherein the button part is formed of a flexible material deformable by an external force and
a plurality of holes are provided around the button.

2. The refrigerator of claim 1, wherein
the plurality of holes are arranged to be spaced apart by a predetermined interval in a circumferential direction of the button.

3. The refrigerator of claim 1, wherein the door comprises:
a support frame configured to support the button device; and
a front frame configured to cover the button device supported by the support frame,
wherein the front frame comprises a button hole exposing a region corresponding to the button to an outside in the button part.

4. The refrigerator of claim 3, wherein
the button part comprises a protrusion configured to protrude along a circumference of the button,
wherein the protrusion is configured to penetrate the button hole, and
wherein a diameter of the protrusion is equal to or greater than a diameter of the button hole.

5. The refrigerator of claim 4, wherein
the protrusion has a ring shape,
wherein the button device further comprises a contact part coupled with the protrusion in a region formed by the protrusion,
wherein the contact part and the front frame are formed of a metal material or
wherein the front frame is formed of a metal material and the contact part is formed of a non-metal material and has the same texture as a texture of the front frame.

6. The refrigerator of claim 5, wherein
the protrusion comprises an engaging portion to be engaged with an edge of the contact part.

7. The refrigerator of claim 5, wherein
the contact part is located in the button hole in a state where the contact part is coupled to the protrusion.

8. The refrigerator of claim 1, wherein
the detection part comprises a board on which the switch is installed, and
wherein a light emitting part is installed on the board and around the switch.

9. The refrigerator of claim 8, wherein
the button part further comprises a pressing part extending from a position corresponding to the button toward the switch, and
wherein the pressing part presses a contact point of the switch when the button is operated.

10. The refrigerator of claim 8, wherein
the button device further comprises reflective member having a passage in which the light emitting part and the switch are accommodated, and
wherein the reflective member is configured to support the button part in the housing.

11. The refrigerator of claim 10, wherein
the reflective member comprises a body in which an inner circumferential surface forms the passage,
wherein an entrance of the passage is located adjacent to the board and an exit of the passage is located adjacent to the button, and
wherein a distance from a center of the switch to the light emitting part is greater than a radius of the exit of the passage.

12. The refrigerator of claim 11, wherein
a diameter of the exit of the passage is smaller than a diameter of the entrance of the passage.

13. The refrigerator of claim 10, wherein
the reflective member further comprises at least one projection inserted into some or all of the plurality of holes.

14. The refrigerator of claim 8, wherein
the button device further comprises a housing configured to accommodate the detection part and to support the button part.

15. The refrigerator of claim 14, wherein
the housing comprises:
a housing body configured to form an accommodation space in which the detection part is accommodated; and
an edge part extending from an edge of the housing body,
wherein the edge part comprises a seating part formed to be recessed to allow the button part to be seated therein.

16. A refrigerator comprising:
a cabinet configured to form a storage space;
an upper door configured to open and close an upper space of the storage space;
a lower door configured to open and close a lower space of the storage space;
a button device provided at the upper door and including a button, a first detection part configured to detect an operation of the button and a light emitting part;
a second detection part provided at the upper door; and
a controller configured to turn on the light emitting part when a detection signal is output from the second detection part.

17. The refrigerator of claim 16, wherein
the second detection part is a knock detection part configured to detect a knock applied to the upper door or a proximity sensor configured to detect a user's approach.

18. The refrigerator of claim 16, further comprising:
at least one of a drawing device configured to automatically draw out the lower door or a lifting device configured to automatically lift a container accommodated at the lower door,
wherein at least one of the drawing device or the lifting device operates when an operation of the button is detected by the first detection part.

19. The refrigerator of claim 16, wherein
the button device is located at a lower portion of a front surface of the upper door.

20. The refrigerator of claim 16, wherein
the upper door comprises a first door and a second door accommodated in the first door so as to be rotatable with respect to the first door, and
wherein the button device is located between the second door and the lower door in the first door.
